(19) United States
(12) Patent Application Publication
(10) Pub. No.: US 2008/0291240 A1
(43) Pub. Date: Nov. 27, 2008

(54) IMAGE FORMING APPARATUS

(75) Inventors: Naoto OHSAKO, Kanagawa (JP); Toshitaka Osanai, Kanagawa (JP); Tetsuya Hiruma, Kanagawa (JP); Nobuyuki Akaishi, Kanagawa (JP); Daisuke Nakamura, Toyama (JP)

Correspondence Address: COOPER & DUNHAM, LLP, 1185 AVENUE OF THE AMERICAS, NEW YORK, NY, 10036, US

(73) Assignee: Richo Company, Ltd., Tokyo (JP)

(21) Appl. No.: 12/122,844

(22) Filed: May 19, 2008

(30) Foreign Application Priority Data
May 26, 2007 (JP) 2007-139789

(51) Int. Cl. B41J 2/165

(52) U.S. Cl. 347/33

(57) ABSTRACT

An image forming apparatus is disclosed. The image forming apparatus executes operations of idle ink ejection in which ink droplets not contributing to forming an image on a recording medium are ejected. When the operations of the idle ink ejection are executed before staring to print an image on a recording medium, the ink droplets are ejected into a cap member; in a case where the operations of the idle ink ejection are executed when a first predetermined period has passed after the last ejection of the ink droplets from the recording head, the ink droplets are ejected into an idle ink droplet receiving section; and in a case where the operations of the idle ink ejection are executed when a second predetermined period longer than the first predetermined period has passed as one of cleaning operations of the recording head, the ink droplets are ejected into the cap member.

### BACKGROUND OF THE INVENTION

1. Field of the Invention

The present invention generally relates to an image forming apparatus having a recording head for ejecting recording liquid droplets and a head maintaining and recovering mechanism for maintaining and recovering the performance of the recording head.

2. Description of the Related Art

As an image forming apparatus such as a printer, a facsimile machine, a copier, and a multifunctional apparatus that has the above functions, for example, there is an apparatus using a liquid ejecting device having a liquid ejecting head which ejects recording liquid (ink) onto a recording medium for forming an image on the recording medium. The recording medium is not limited to a sheet, and other recording media such as an image transferring medium and recording paper can be used as the recording medium; and the image forming includes image recording, image printing, letter printing, letter transferring and so on.

The image forming apparatus forms an image on a recording medium formed of materials such as paper, thread, string, cloth, leather, metal, glass, wood, plastic, and ceramics by ejecting recording liquid onto the recording medium. Further, the image forming includes attaching an image such as a pattern onto a recording medium in addition to attaching an image having a meaning such as a letter and a figure onto the recording medium. The recording liquid is not limited to ink and can be fluid to be ejected for forming an image on a recording medium. In addition, the liquid ejecting device signifies a device that ejects liquid from a liquid ejecting head.

In the image forming apparatus having the liquid ejecting device which forms an image on a recording medium, a head maintaining and recovering mechanism is provided which maintains and recovers (corrects) the performance of the recording head for ejecting recording liquid.

The head maintaining and recovering mechanism (device) includes a humidity keeping cap, a suction cap, a wiper member (wiper, wiper blade), a wiper cleaner, and a remaining recording liquid receiving member. The humidity keeping cap covers a nozzle surface of the recording head for keeping high airtight conditions; the suction cap is connected to a suction unit, for example, a suction pump so as to suction viscosity-increased ink from a nozzle and discharge the ink; the wiper member removes ink adhered onto the nozzle surface by wiping; the wiper cleaner cleans the wiper member; and the remaining recording liquid receiving member receives recording liquid which does not contribute to forming an image. In some cases, the humidity keeping cap also works as the suction cap.

In Patent Document 1, an inkjet recording apparatus is disclosed. The inkjet recording apparatus provides a first ink receiving section and a second ink receiving section for executing a preliminary ejection of ink which is one of operations of idle ink ejection right before printing an image on a recording medium so that mixing of colors is prevented.

The operations of the idle ink ejection are to ensure that remaining ink droplets on the recording head not contributing to forming an image are ejected so that output image quality is not degraded.

In Patent Document 2, an inkjet recording apparatus is disclosed. In the inkjet recording apparatus, when flushing operations of liquid droplets are executed, the liquid droplets are ejected to a capping unit while the capping unit seals a nozzle surface of a recording head.

In Patent Document 3, a liquid ejecting device is disclosed. In the liquid ejecting device, after executing suctioning operations of liquid from a nozzle while a cap member is in close contact with a liquid ejecting section of a liquid ejecting head, during separation of the cap member from the liquid ejecting head, the liquid ejecting head ejects liquid into the cap member.

In Patent Document 4, an inkjet recording apparatus is disclosed. In the inkjet recording apparatus, while an extremely short distance is kept between a nozzle surface and a cap member, liquid droplets are ejected into the cap member in head recovering operations.

[Patent Document 1] Japanese Laid-Open Patent Application No. 2001-113714

[Patent Document 2] Japanese Laid-Open Patent Application No. 2001-322296

[Patent Document 3] Japanese Laid-Open Patent Application No. 2002-127453

[Patent Document 4] Japanese Laid-Open Patent Application No. 6-344570

As the other relating Patent Documents, Patent Documents 5 through 8 exist.

[Patent Document 5] Japanese Patent No. 3852883 (Japanese Laid-Open Patent Application No. 11-198405)

[Patent Document 6] Japanese Laid-Open Patent Application No. 2006-044146

[Patent Document 7] Japanese Laid-Open Patent Application No. 2004-130693

[Patent Document 8] Japanese Laid-Open Patent Application No. 2003-072123

However, in the image forming apparatus, in order to realize high-speed recording, since ink (recording liquid) must have quick-drying ability, pigment based ink having high viscosity is generally used. In this, the high viscosity ink is defined to have 5 cP or more viscosity. Therefore, in a case where only one section is used as the remaining recording droplet receiving section for receiving the ink droplets not contributing to forming an image, especially, when the image forming apparatus is continuously used under a low humidity environment, the viscosity-increased ink is stacked at the remaining droplet receiving section. Consequently, in many cases, the stacked ink becomes a pole-shaped stack and contacts the nozzle surface of the recording head, and image quality may be degraded.

In Patent Document 1, even if two ink receiving sections are used in the preliminary ejection of ink before recording an image, since the idle ink ejection is executed only in the preliminary ejection, the viscosity-increased ink is stacked in the ink receiving sections.

The remaining ink droplet ejecting operations (operations of idle ink ejection) are executed in the following cases. In a first case, the operations of the idle ink ejection are executed before forming an image on a recording medium. In a second case, the operations of the idle ink ejection are executed after the image forming apparatus has not been used for a predetermined period. In a third case, the operations of the idle ink ejection are executed as one of cleaning operations; that is, in the cleaning operations, after the image forming apparatus has not been used for another predetermined period longer than the predetermined period, the remaining ink droplets are suctioned by capping the recording head with the cap member, the nozzle surface of the recording head is wiped by the wiper member and the remaining ink droplets are collected, the wiper member is cleaned by the wiper cleaner, and the remaining ink droplets are collected; with this, the operations of the idle ink ejection are executed.

When the operations of the idle ink ejection are applied only to the cap member, ink droplets discharged from the cap member are stacked in a waste ink tank, the stacked ink becomes a pole-shaped stack, and this makes the service life of the waste ink tank short. In addition, when the operations of the idle ink ejection are applied only to the remaining ink droplet receiving section, ejected ink droplets are stacked in the remaining ink droplet receiving section and the stacked ink droplets make the service life of the remaining ink droplet receiving section short. Further, when the remaining ink droplet receiving section includes a scraping mechanism for scarping the ink droplets on the wiper member, the scraping mechanism abnormally operates due to the viscosity-increased ink in the remaining ink droplet receiving section. Consequently, the service life of the image forming apparatus becomes short.

In Patent Document 1, since the ink droplets due to the preliminary ejection are simply discharged into the two ink receiving sections, shortening the service life of the waste ink tank, the remaining ink droplet receiving section, and the image forming apparatus is not solved.

### SUMMARY OF THE INVENTION

In a preferred embodiment of the present invention, there is provided an image forming apparatus having a recording head for ejecting recording liquid droplets and a head maintaining and recovering mechanism for maintaining and recovering the performance of the recording head in which shortening the service life of the image forming apparatus due to a stack of viscosity-increased ink is prevented.

Features and advantages of the present invention are set forth in the description that follows, and in part will become apparent from the description and the accompanying drawings, or may be learned by practice of the invention according to the teachings provided in the description. Features and advantages of embodiments of the present invention will be realized and attained by an image forming apparatus having a recording head for ejecting recording liquid droplets and a head maintaining and recovering mechanism for maintaining and recovering the performance of the recording head particularly pointed out in the specification in such full, clear, concise, and exact terms so as to enable a person having ordinary skill in the art to practice the invention.

To achieve one or more of these and other advantages, according to one aspect of the present invention, there is provided an image forming apparatus. The image forming apparatus includes a recording head having nozzles which eject liquid droplets for forming an image on a recording medium, and a head maintaining and recovering mechanism. The head maintaining and recovering mechanism includes a cap member for capping a nozzle surface of the recording head, a wiper member for wiping the nozzle surface of the recording head so that the liquid droplets remaining on the nozzle surface are wiped, a wiper cleaning member for scraping the wiper member so that the liquid droplets remaining on the wiper member are removed from the wiper member, and an idle liquid droplet receiving section which receives the liquid droplets ejected from the recording head not contributing to forming the image and also receives the liquid droplets scraped from the wiper member. The recording head executes a plurality types of idle liquid droplet ejections by ejecting the liquid droplets not contributing to forming the image according to a time period during the recording head not ejecting liquid droplets, and the recording head ejects the liquid droplets into the idle liquid droplet receiving section in a first case of the idle liquid droplet ejection when a first predetermined period has passed after the last ejection of the liquid droplets from the recording head, and ejects the liquid droplets into the cap member in cases other than the first case of the idle liquid drop let ejection.

According to another aspect of the present invention, there is provided an image forming apparatus. The image forming apparatus includes a recording head having nozzles which eject liquid droplets for forming an image on a recording medium, and a head maintaining and recovering mechanism. The head maintaining and recovering mechanism includes a cap member for capping a nozzle surface of the recording head, a wiper member for wiping the nozzle surface of the recording head so that the liquid droplets remaining on the nozzle surface are wiped, a wiper cleaning member for scraping the wiper member so that the liquid droplets remaining on the wiper member are removed from the wiper member, and an idle liquid droplet receiving section which receives the liquid droplets ejected from the recording head not contributing to forming the image and also receives the liquid droplets scraped from the wiper member. The recording head executes a plurality types of idle liquid droplet ejections, amount of total ejected liquid droplets of which are different from each other, by ejecting the liquid droplets not contributing to forming the image, and the recording head ejects the liquid droplets into at least one of the idle liquid droplet receiving section and the cap member according to the total ejected liquid droplets ejected by the plurality types of idle liquid droplet ejections.

### EFFECT OF THE INVENTION

According to an embodiment of the present invention, in an image forming apparatus, when idle liquid droplet ejections are executed in which remaining liquid droplets not contributing to forming an image are ejected, liquid droplets are ejected into an idle liquid droplet receiving section in a first case where the idle liquid droplet ejection is executed when a first predetermined period has passed after the last ejection of the liquid droplets from the recording head, and the liquid droplet are ejected into a cap member in cases other than the first case. That is, first, the liquid droplets are ejected into the idle liquid droplet receiving section or the cap member, and finally, the liquid droplets are collected in a waste liquid droplet tank. Therefore, a stack of viscosity-increased liquid droplets is hardly formed in the waste liquid droplet tank and the idle liquid droplet receiving section. Consequently, the service lives of the waste liquid droplet tank and the idle liquid droplet receiving section can be prevented from being shortened, and the service life of the image forming apparatus can be prevented from being shortened.

In addition, in the image forming apparatus, when the idle liquid droplet ejections are executed, the amount of the liquid droplets to be ejected is determined in several cases, and the liquid droplet are ejected into the idle liquid droplet receiving section or the cap member by selecting one of the idle liquid droplet receiving section and the cap member depending on the amount of the liquid droplets to be ejected in the cases. Therefore, a stack of viscosity-increased liquid droplets is hardly formed in the waste liquid droplet tank and the idle liquid droplet receiving section. Therefore, the service lives of the waste liquid droplet tank and the idle liquid droplet receiving section can be prevented from being shortened. Consequently, the service life of the image forming apparatus can be prevented from being shortened.

### BRIEF DESCRIPTION OF THE DRAWINGS

Features and advantages of the present invention will become more apparent from the following detailed description when read in conjunction with the accompanying drawings, in which:

FIG. 1 is a schematic diagram showing a structure of an image forming apparatus according to an embodiment of the present invention;

FIG. 2 is a plan view of a main part of the image forming apparatus shown in FIG. 1;

FIG. 3 is a schematic diagram showing a head maintaining and recovering mechanism shown in FIG. 2;

FIG. 4 is an enlarged view of a main part of the head maintaining and recovering mechanism shown in FIG. 2;

FIG. 5 is a plan view of a part of the head maintaining and recovering mechanism shown in FIG. 2;

FIG. 6 is a block diagram showing a controller of the image forming apparatus according to the embodiment of the present invention;

FIG. 7 is a schematic diagram showing a status in which the head maintaining and recovering mechanism is at a home position;

FIG. 8 is a schematic diagram showing a capping status of the head maintaining and recovering mechanism;

FIG. 9 is a schematic diagram showing a wiping status of the head maintaining and recovering mechanism;

FIG. 10 is a schematic diagram showing a status after the wiping status of the head maintaining and recovering mechanism shown in FIG. 9;

FIG. 11 is a schematic diagram showing first idle ink ejection to a cap member by using the head maintaining and recovering mechanism;

FIG. 12 is a schematic diagram showing second idle ink ejection to the cap member by using the head maintaining and recovering mechanism;

FIG. 13 is a schematic diagram showing first idle ink ejection to an idle ink droplet receiving section by using the head maintaining and recovering mechanism;

FIG. 14 is a schematic diagram showing second idle ink ejection into the idle ink droplet receiving section by using the head maintaining and recovering mechanism;

FIG. 15 is a flowchart showing operations of idle ink ejection according to the embodiment of the present invention; and

FIG. 16 is a flowchart showing an example of cleaning operations of the recording head according to the embodiment of the present invention.

### DESCRIPTION OF THE PREFERRED EMBODIMENT

### BESCT MODE OF CARRYING OUT THE INVENTION

The best mode of carrying out the present invention is described with reference to the accompanying drawings.

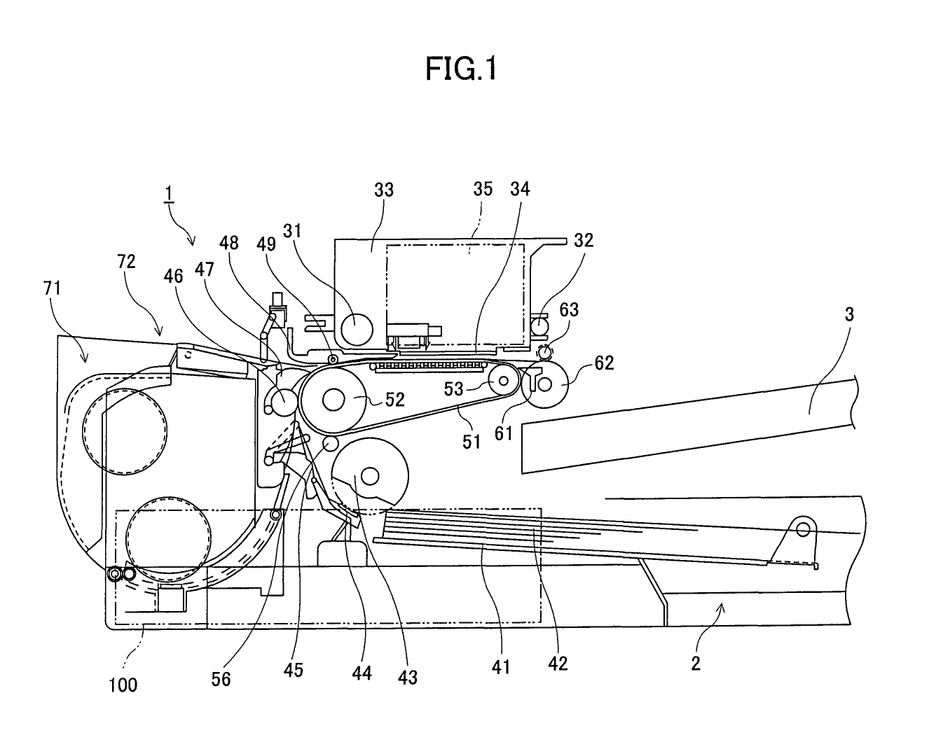

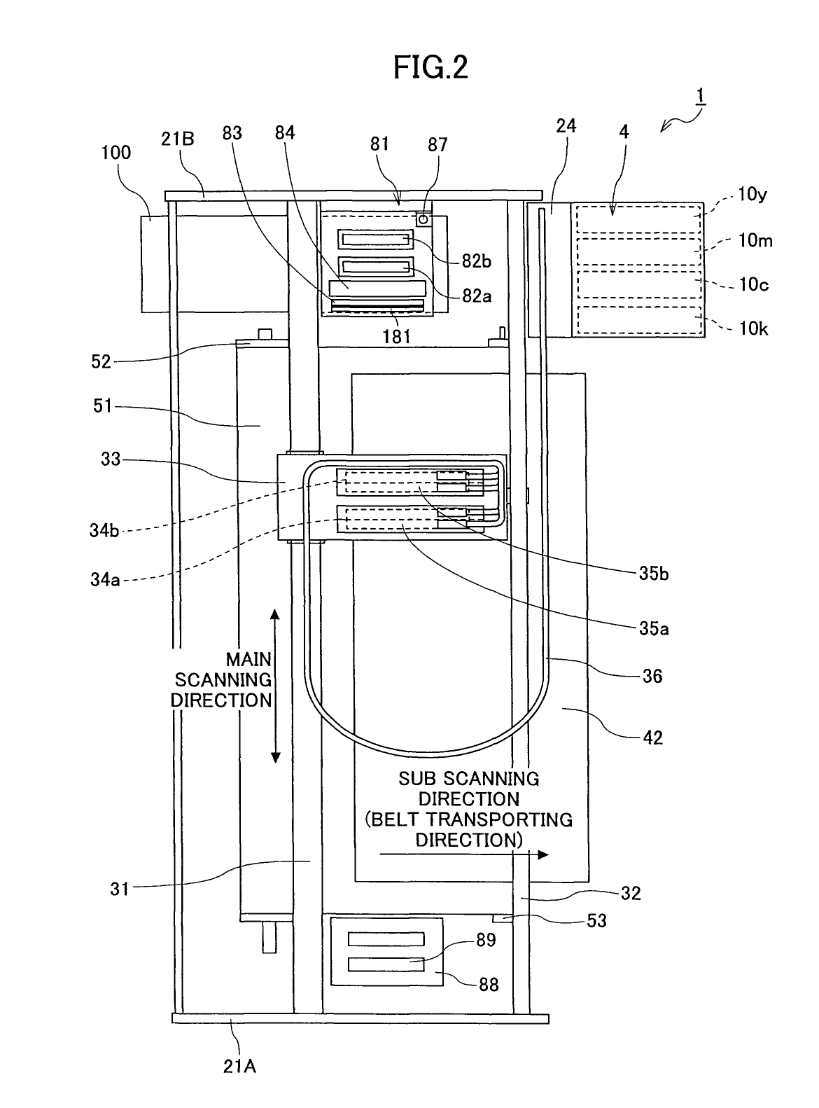

First, referring to FIGS. 1 and 2, an image forming apparatus according to an embodiment of the present invention is described. FIG. 1 is a schematic diagram showing a structure of the image forming apparatus according to the embodiment of the present invention. FIG. 2 is a plan view of a main part of the image forming apparatus shown in FIG. 1.

The image forming apparatus shown in FIG. 1 is a serial type image forming apparatus. In the image forming apparatus, a carriage 33 is slidably held in the main scanning direction by a driving guide rod 31 and a driven guide rod 32 held between side plates 21A and 21B of an apparatus main body 1, and the carriage 33 is moved in the main scanning direction (the arrow direction shown in FIG. 2) by a main scanning direction motor (not shown) via a timing belt (not shown).

Recording heads 34a and 34b for ejecting ink droplets (liquid droplets) of yellow (Y), cyan (C), magenta (M), and black (K) are disposed in the carriage 33. When color is not referred to, the recording head 34 is used to represent the recording heads 34a and 34b. The recording head 34 includes a nozzle array formed of plural nozzles in the sub scanning direction orthogonal to the main scanning direction, and the ink droplet ejecting direction from the nozzle array faces the downward direction.

The recording head 34a provides the two nozzle arrays, and one of the two nozzle arrays ejects black (K) ink droplets and the other of the two nozzle arrays ejects cyan (C) ink droplets. The recording head 34b provides the two nozzle arrays, and one of the two nozzle arrays ejects magenta (M) ink droplets and the other of the two nozzle arrays ejects yellow (Y) ink droplets.

The carriage 33 further provides head tanks 35a and 35b from which ink is supplied to the nozzle arrays of the recording head 34. When color is not referred to, the head tank 35 is used to represent the head tanks 35a and 35b. Recording liquid cartridges 10y, 10m, 10c, and 10k where corresponding color recording liquids are stored are detachably attached to a cartridge storing section 4. The color recording liquid is supplied to the head tank 35 from the corresponding recording liquid cartridges 10y, 10m, 10c, and 10k via an ink supplying tube 36 by operations of an ink supplying pump unit (not shown). When color is not referred to, a recording liquid cartridge 10 represents the recording liquid cartridges 10y, 10m, 10c, and 10k.

In order to feed a sheet (paper) 42 stacked on a sheet storing section 41 (thick board) of a sheet feeding tray 2 to an image forming region, the image forming apparatus includes a half-moon roller 43 (sheet feeding roller) for feeding each sheet 42 one by one from the sheet storing section 41 and a separation pad 44 formed of a material having a high friction coefficient. The separation pad 44 is pushed toward the sheet feeding roller 43.

In addition, in order to transport the sheet 42 to a position under the recording head 34, the image forming apparatus includes a guide member 45 for guiding the sheet 42, a counter roller 46, a sheet transporting guide member 47, a pushing member 48 having a sheet tip pushing roller 49, and a transport belt 51 (transport unit) for transporting the sheet 42 to a position facing the recording head 34 by adhering the sheet 42 with an electrostatic force.

The transport belt 51 is an endless belt which is wound around a transporting roller 52 and a tension roller 53, and moves in the belt transporting direction (the sub scanning direction) at the position facing the recording head 34. The image forming apparatus further includes a charging roller 56 (charging unit) for charging the surface of the transport belt 51. The charging roller 56 is rotated by the rotation of the transport belt 51 by contacting the surface of the transport belt 51. The transport belt 51 is rotated in the belt transporting direction (the arrow direction shown in FIG. 2) by a sub scanning direction motor (not shown) via a timing belt (not shown).

In order to output the sheet 42 on which an image is formed by the recording head 34, the image forming apparatus further includes a separation claw 61 for separating the sheet 42 from the transport belt 51, a sheet outputting roller 62, a spur 63, and a sheet outputting tray 3 under the sheet outputting roller 62.

In addition, a duplex print unit 71 is detachably attached to the apparatus main body 1 on the back surface of the apparatus main body 1. The duplex print unit 71 receives the sheet 42 returned from the transport belt 51 by the reverse rotation of the transport belt 51, inverts the sheet 42, and transports the inverted sheet 42 between the counter roller 46 and the transport belt 51. The upper surface of the duplex print unit 71 is a manual sheet feeding tray 72.

In addition, as shown in FIG. 2, a head maintaining and recovering mechanism 81 is disposed at a non-printing region located at one side in the scanning direction of the carriage 33 in the apparatus main body 1. The head maintaining and recovering mechanism 81 maintains normal conditions of the nozzles of the recording head 34 and recovers from abnormal conditions of the nozzles of the recording head 34.

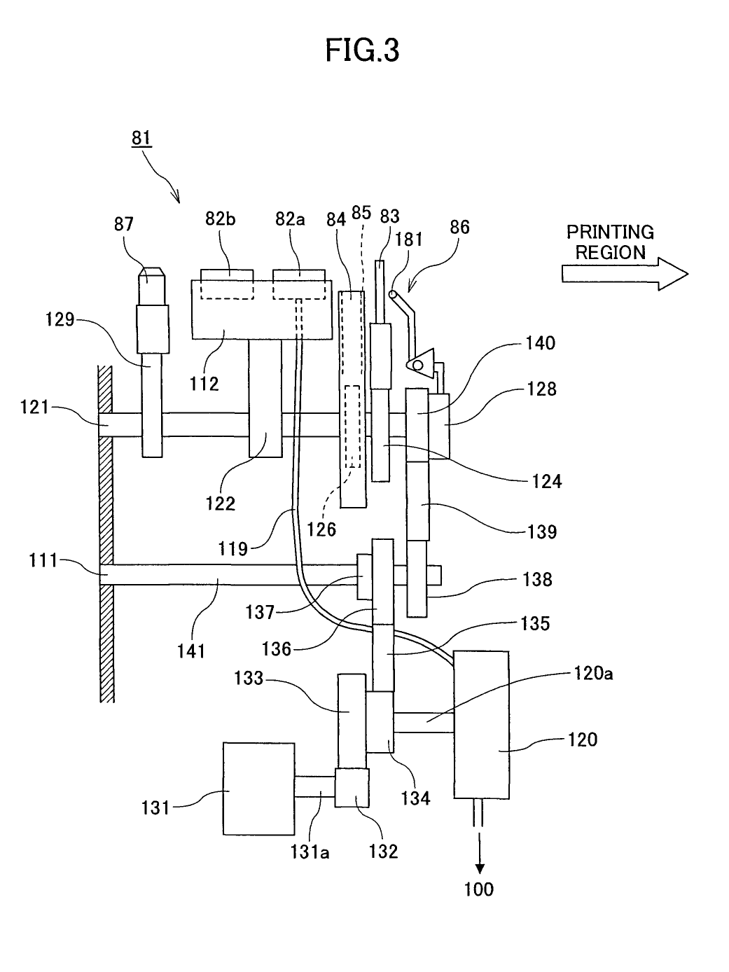

The head maintaining and recovering mechanism 81 includes cap members 82a and 82b for capping the nozzle surfaces of the recording head 34, a wiper member 83 (wiper blade) for wiping the nozzle surfaces of the recording head 34, an idle ink droplet receiving section 84 for receiving ink droplets (liquid droplets) whose viscosity becomes high by not contributing to forming an image, a wiper cleaning section 85 (see FIG. 3) formed with the idle ink droplet receiving section 84 for removing ink adhered onto the wiper member 83, a wiper cleaner 86 (see FIG. 3) for pushing the wiper member 83 toward the wiper cleaning section 85 when the wiper member 83 is cleaned, and a carriage lock 87 for locking the carriage 33. In some cases, a cap member 82 represents the cap members 82a and 82b. The idle ink droplet receiving section 84 mainly receives the ink droplets by the operations of the idle ink ejection. In addition, a waste ink tank 100 is detachably attached to the apparatus main body 1 under the head maintaining and recovering mechanism 81 for storing waste ink discharged by the operations of the head maintaining and recovering mechanism 81.

Further, as shown in FIG. 2, in a non-printing region located at the other side in the scanning direction of the carriage 33 in the apparatus main body 1, an idle ink droplet receiving section 88 is disposed for receiving ink droplets whose viscosity becomes high by not contributing to forming an image. The idle ink droplet receiving section 88 includes openings 89 along the nozzle arrays of the recording head 34.

In the image forming apparatus, the sheet 42 is fed from the sheet feeding tray 2 one by one in a direction approximately vertical direction, the sheet 42 is guided by the guide member 45, and is transported between the transport belt 51 and the counter roller 46. The tip of the sheet 42 is guided by the sheet transporting guide member 47 and is pushed onto the transport belt 51 by the sheet tip pushing roller 49. Then the transport direction of the sheet 42 is changed to approximately 90 degrees relative to the original direction.

At this time, an alternating voltage is applied onto the charging roller 56 and the surface of the transport belt 51 attains an alternating voltage charged pattern in which positive electric charges and negative electric charges are alternately applied on the surface of the transport belt 51 with a predetermined width in the sub scanning direction. When the sheet 42 is transported on the transport belt 51 whose surface is alternately charged by the positive electric charges and the negative electric charges, the sheet 42 is adhered onto the surface of the transport belt 51 and is transported in the sub scanning direction by the rotation of the transport belt 51.

When the recording head 34 is driven corresponding an image signal while the carriage 33 is moved, the recording head 34 ejects ink droplets on the stopped sheet 42 and one line of an image is recorded (printed) on the sheet 42. Then the sheet 42 is transported by a predetermined length and the next line of the image is recorded on the sheet 42. When the image forming apparatus receives a printing completion signal or a signal that the back end of the sheet 42 has reached the end of the printing region of the apparatus main body 1, the image forming apparatus ends the printing operations and outputs the sheet 42 to the sheet outputting tray 3.

When the maintaining and recovering operations of the nozzles of the recording head 34 are executed, the carriage 33 is move to a home position of the carriage 33 facing the head maintaining and recovering mechanism 81. At the position, ink droplet suctioning operations are executed while capping the nozzle surfaces of the recording head 34 by the cap member 82, and the remaining ink droplets which do not contribute to forming an image are ejected by idle ejection. With this, an image can be formed by a stable ink droplet ejection.

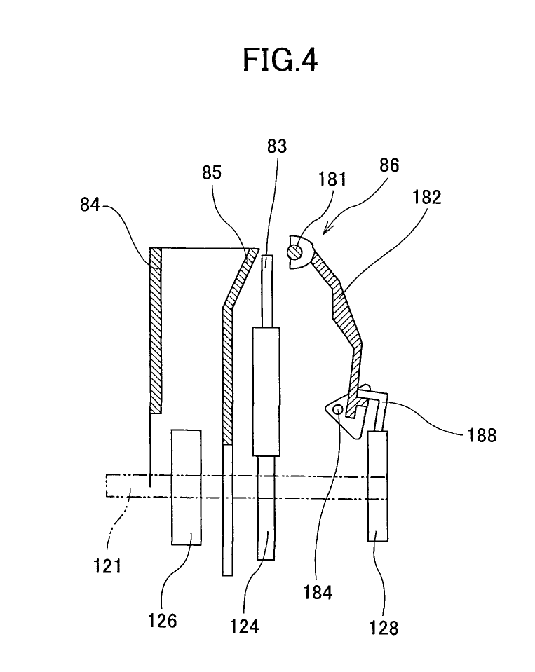

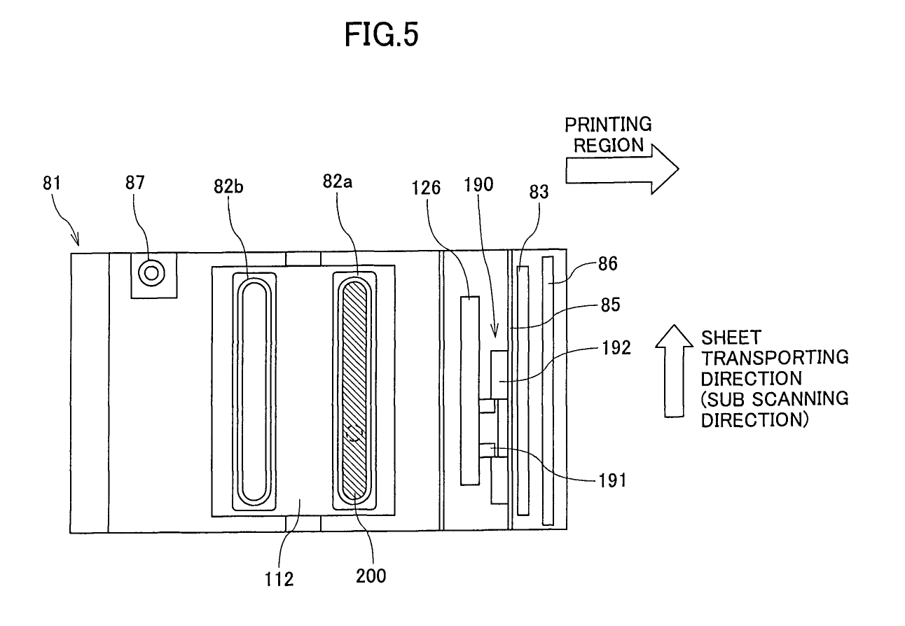

Next, referring to FIGS. 3 through 5, the head maintaining and recovering mechanism 81 is described. FIG. 3 is a schematic diagram showing the head maintaining and recovering mechanism 81. FIG. 4 is an enlarged view of a main part of the head maintaining and recovering mechanism 81. FIG. 5 is a plan view of a part of the head maintaining and recovering mechanism 81.

In the head maintaining and recovering mechanism 81, the cap members 82a and 82b held by a cap holder 112, the wiper member 83 including a flexible member, and the wiper cleaner 86 are movably sustained by a mechanism frame 111 in the up and down direction.

In addition, in the head maintaining and recovering mechanism 81, the idle ink droplet receiving section 84 is located between the wiper member 83 and the cap member 82a. The idle ink droplet receiving section 84 is formed in a cylinder shape, and the cap member 82a is used to suction ink droplets. The wiper cleaning section 85 is formed at an upper end in the idle ink droplet receiving section 84 near the wiper member 83. The wiper cleaning section 85 scrapes ink droplets adhered onto the wiper member 83 into the idle ink droplet receiving section 84. When the wiper member 83 is cleaned, the wiper member 83 is moved downward while the wiper cleaner 86 pushes the wiper member 83 to the wiper cleaning section 85. With this, the ink droplets adhered onto the wiper member 83 are scraped into the idle ink droplet receiving section 84.

The wiper cleaner 86 includes a cleaner roller 181 for contacting the wiper member 83 and a cleaner holder 182. The cleaner roller 181 is rotatably held by the cleaner holder 182 at the upper end of the cleaner holder 182. The cleaner roller 181 pushes the wiper member 83 into contact with the wiper member 83. The cleaner holder 182 is swingably attached to the mechanism frame 111 by an axle 184 and is normally located at a position where the cleaner roller 181 does not contact the wiper member 83 by the force of a spring (not shown). In addition, a link member 188 is disposed to swing the cleaner holder 182.

The idle ink droplet receiving section 84 includes an ink scraping mechanism 190 for scraping ink droplets transferred onto the wiper cleaning section 85 from the wiper member 83. The ink scraping mechanism 190 scraps the ink droplets transferred onto wiper cleaning section 85 by causing a scraping member 192 to swing. The scraping member 192 is swung by a boss 191 (ink droplet scraping member) of a roller 126 (described below) when the roller 126 is rotated.

A suction pump 120 (tubing pump) is connected to the cap member 82a located at the position nearest to the printing region via a flexible tube 119. The cap member 82a is used to suction ink droplets and is also used to maintain humidity, and the cap member 82b is used only to maintain humidity. Therefore, when the nozzles of the recording head 34 are maintained or recovered, the recording head 34 is moved to a position where the cap member 82a can cap the recording head 34. The cap member 82a includes an ink absorbing member 200.

In addition, a camshaft 121 is under the cap members 82a and 82b, and the wiper member 83. The camshaft 121 is rotatably sustained by the mechanism frame 111. A cap cam 122, a wiper cam 124, the roller 126, a cleaner cam 128, and a carriage lock cam 129 are attached to the camshaft 121. The cap cam 122 moves the cap holder 112 up and down, the wiper cam 124 moves the wiper member 83 up and down, the cleaner cam 128 swings the wiper cleaner 86, and the carriage lock cam 129 moves the carriage lock 87 up and down.

When the wiper member 83 is moved down by the wiper cam 124, the wiper cleaner 86 contacts the wiper member 83, and the wiper member 83 is moved down by being sandwiched between the cleaner roller 181 of the wiper cleaner 86 and the wiper cleaning section 85 of the idle ink droplet receiving section 84. With this, the ink adhered onto the wiper member 83 is scraped into the idle ink droplet receiving section 84. Since the ink droplets are adhered onto the inside surface of the wiper member 83, the ink droplets are scraped into the idle ink droplet receiving section 84 by the wiper cleaning section 85 with the downward-movement of the wiper member 83.

In order to drive the suction pump 120 and rotate the camshaft 121, the following gear mechanism is used. In the mechanism, the rotation of the motor 131 is transmitted to a motor gear 132 attached to a motor shaft 131a, and the motor gear 132 engages a pump gear 133 attached to a pump shaft 120a of the suction pump 120. Further, an intermediate gear 134 formed with the pump gear 133 engages an intermediate gear 136 having a one-way clutch 137 via an intermediate gear 135, an intermediate gear 138 whose axle is the same as the axle of the intermediate gear 136 engages a cam gear 140 secured to the camshaft 121 via an intermediate gear 139. A shaft 141 that is a rotational axle of the intermediate gear 136 having the one-way clutch 137 and the intermediate gear 138 is rotatably held by the mechanism frame 111.

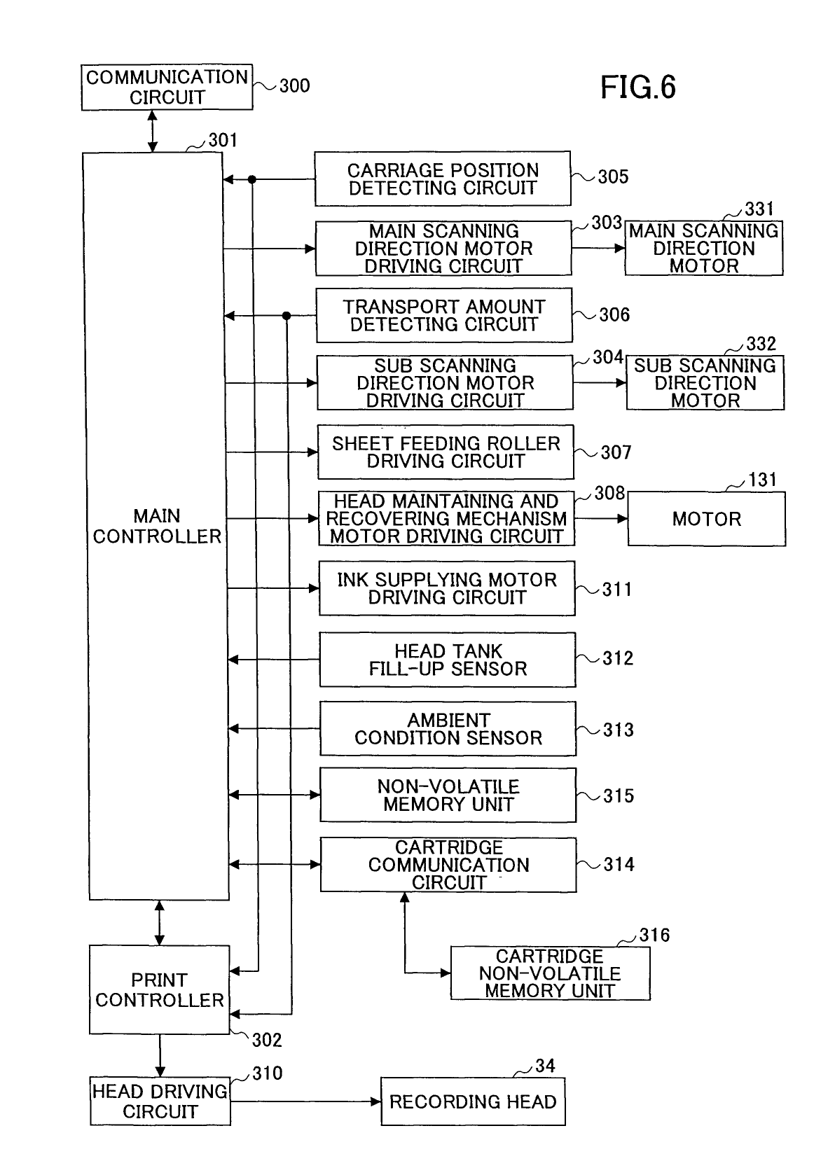

Next, referring to FIGS. 1, 2, and 6, a controller of the image forming apparatus is described. FIG. 6 is a block diagram showing the controller of the image forming apparatus according to the embodiment of the present invention.

The controller controls all operations (elements) of the image forming apparatus and includes a main controller 301 and a print controller 302. The main controller 301 is a microcomputer including a unit for controlling the operations of the idle ink ejection. The print controller 302 is a microcomputer for controlling printing operations.

The main controller 301 controls (drives) a main scanning direction motor driving circuit 303 and a sub scanning direction motor driving circuit 304 so that an image is formed on the sheet 42 based on print processing information input from a communication circuit 300. The main scanning direction motor driving circuit 303 drives a main scanning direction motor 331 so that the carriage 33 is moved in the main scanning direction, and the sub scanning direction motor driving circuit 304 drives a sub scanning direction motor 332 so that the transporting roller 52 is rotated. In addition, the main controller 301 outputs print data to the print controller 302.

A detection signal is input to the main controller 301 which signal is a positional signal of the carriage 33 detected by a carriage position detecting circuit 305, and the main controller 301 controls the moving speed and the moving position of the carriage 33 based on the detection signal. The carriage position detecting circuit 305 detects the position and the speed of the carriage 33, for example, by counting the number of slits of an encoder sheet (not shown) disposed in the scanning direction of the carriage 33 by using a photo-sensor (not shown) disposed on the carriage 33. The main scanning direction motor driving circuit 303 rotates (drives) the main scanning direction motor 331 corresponding to the moving amount and speed of the carriage 33 output from the main controller 301 and moves the carriage 33 to a predetermined position at a predetermined speed.

In addition, a detection signal is input to the main controller 301 which signal is a transport amount signal of the transport belt 51 detected by a transport amount detecting circuit 306, and the main controller 301 controls the transport speed and the transport amount of the transport belt 51 based on the detection signal. The transport amount detecting circuit 306 detects the transport amount and the transport speed of the transport belt 52, for example, by counting (reading) the number of slits of a rotary encoder sheet (not shown) attached to the axle of the transporting roller 52 by using a photo-sensor (not shown). The sub scanning direction motor driving circuit 304 rotates (drives) the sub scanning direction motor 332 corresponding to a transport amount output from the main controller 301 and moves the transport belt 51 to a predetermined position at a predetermined speed by rotating the transporting roller 52.

The main controller 301 causes the sheet feeding roller 43 to rotate once by giving a sheet feeding roller driving instruction to a sheet feeding roller driving circuit 307. The main controller 301 moves the cap member 82 and the wiper member 83 up and down, and drives the suction pump 120 by driving (rotating) the motor 131 of the head maintaining and recovering mechanism 81 via a head maintaining and recovering mechanism motor driving circuit 308.

The main controller 301 controls supplying ink from the recording liquid cartridge 10 in the cartridge storing section 4 to the head tank 35 by driving an ink supplying motor (not shown) which drives a ink supplying pump (not shown) via an ink supplying motor driving circuit 311. The main controller 301 controls supplying the ink based on a detection signal from a head tank fill-up sensor 312 which detects a fill-up status of the head tank 35.

The main controller 301 obtains information, for example, an ink storing status in the recording liquid cartridge 10, from a cartridge non-volatile memory unit 316 attached to the recording liquid cartridge 10 via a cartridge communication circuit 314, and stores the information in a non-volatile memory unit 315 (for example, EEPROM).

In addition, the main controller 301 obtains a detection signal from an ambient condition sensor 313 which detects ambient temperature and ambient humidity.

The print controller 302 forms image data so as to drive a pressure generating unit (not shown) which causes the recording head 34 to eject ink droplets on the sheet 42 based on signals from the main controller 301 such as the position of the carriage 33 detected from the carriage position detecting circuit 305, and the transport amount of the transport belt 51 detected from the transport amount detecting circuit 306.

The print controller 302 transfers the image data to a head driving circuit 310 as serial data, and also outputs a transfer clock and a clutch signal which are needed to transfer and determine the image data and an ink droplet control signal (mask signal) to the head driving circuit 310.

In addition, the print controller 302 includes a DAC (digital to analog converter) (not shown) which converts pattern data of a driving signal stored in a ROM (not shown) into analog data, a driving waveform generating section (not shown) including a voltage amplifier and a current amplifier, and a driving waveform selecting unit (not shown) which outputs a driving waveform to a head driver (not shown). The print controller 302 generates a driving waveform including a driving signal group formed of one driving pulse (driving signal) or plural driving pulses and outputs the driving waveform to the head driving circuit 310.

The head driving circuit 310 drives the recording head 34 by applying a driving signal to a driving element (for example, a piezoelectric element) which selectively generates energy for ejecting ink droplets from the recording head 34. The driving signal includes the driving waveform given from the print controller 302 based on the image data of one line of the recording head 34 input as serial data. At this time, by selecting a driving pulse in the driving waveform, dots having different sizes can be ejected. For example, a large ink droplet (large dot), a medium ink droplet (medium dot), and a small ink droplet (small dot) can be ejected.

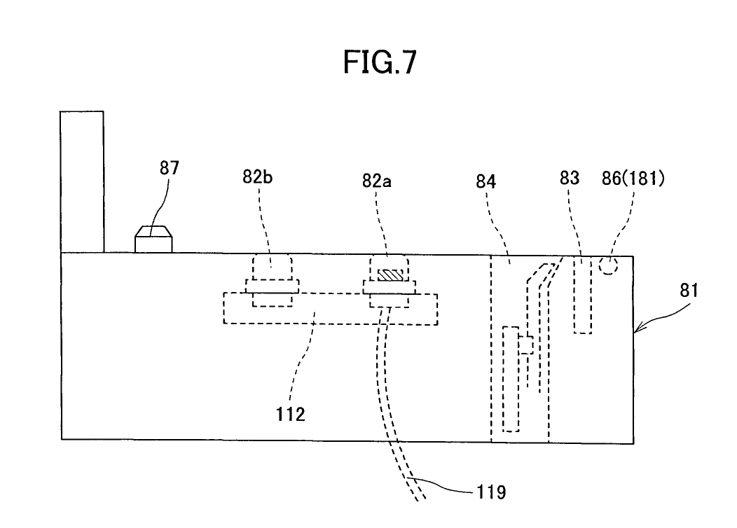

Next, referring to the drawings, the operations of the head maintaining and recovering mechanism 81 are described. FIG. 7 is a schematic diagram showing a status in which the head maintaining and recovering mechanism 81 is at the home position.

At the home position, the head maintaining and recovering mechanism 81 receives the remaining ink droplets which do not contribute to forming an image from the recording head 34 without influencing forming the image by the recording head 34.

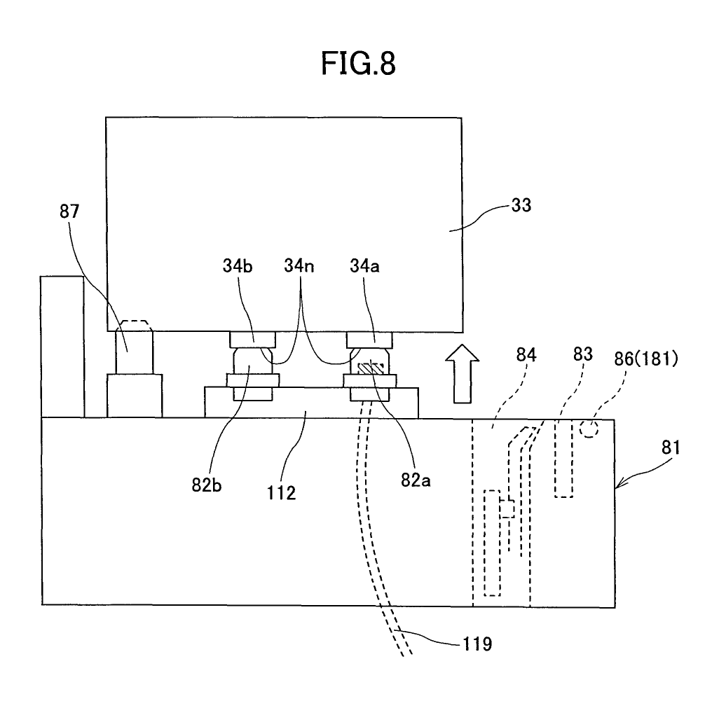

FIG. 8 is a schematic diagram showing a capping status of the head maintaining and recovering mechanism 81. In the capping status, as shown in FIG. 8, the cap members 82a and 82b cap nozzle surfaces 34n of the recording heads 34a and 34b by the lifting of the cap holder 112, and the carriage 33 is locked by engaging the carriage lock 87 with a concave section (not shown) while the carriage lock 87 is lifted. In the capping status, the suction pump 120 (see FIG. 3) is driven and the suctioning operations for suctioning ink droplets from the nozzle surfaces 34n of the recording head 34 are executed.

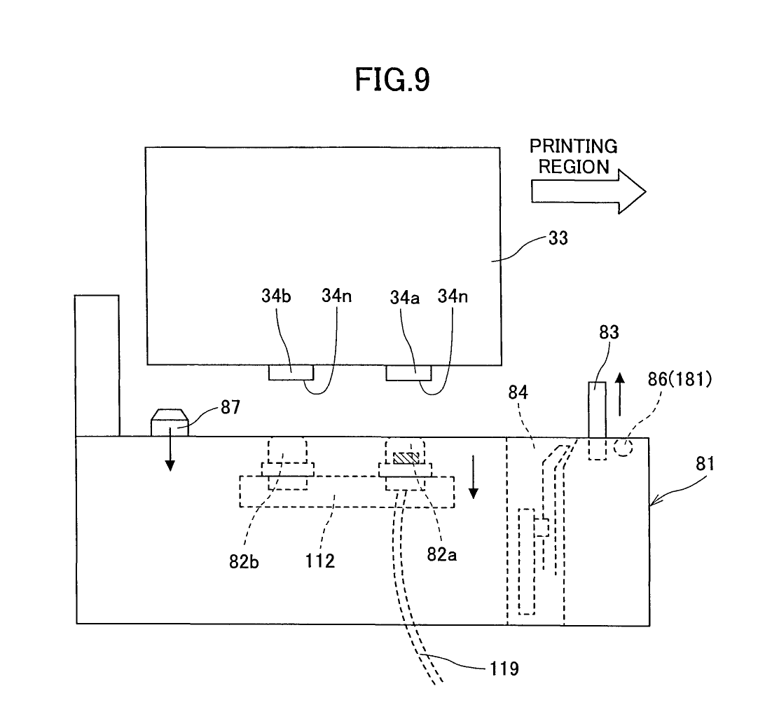

FIG. 9 is a schematic diagram showing a wiping status of the head maintaining and recovering mechanism 81. In the wiping status, as shown in FIG. 9, the wiper member 83 is lifted and the nozzle surfaces 34n of the recording heads 34a and 34b are wiped by the wiper member 83 while the carriage 33 is moved toward the printing region.

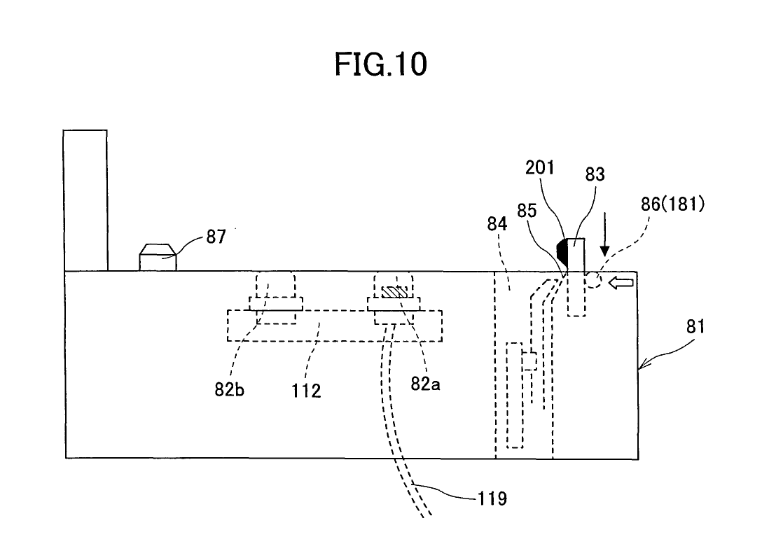

FIG. 10 is a schematic diagram showing a status after the wiping status of the head maintaining and recovering mechanism 81 shown in FIG. 9. As shown in FIG. 10, after the wiping status, the wiper cleaner 86 moves in the white arrow direction and pushes the wiper member 83 to the wiper cleaning section 85 and waste ink 201 adhered onto the wiper member 83 is transferred onto the wiper cleaning section 85 while the wiper member 83 is moved downward. The waste ink 201 is ink droplets wiped from the nozzle surfaces 34n of the recording heads 34a and 34b by the operations shown in FIG. 9.

The waste ink 201 on the wiper cleaning section 85 is scraped into the idle ink droplet receiving section 84 by reciprocating operations of the boss 191 (ink scraping member) (see FIG. 5) of the ink scraping mechanism 190 (see FIG. 3). Finally, the waste ink 201 is discharged into the waste ink tank 100 (see FIG. 2) from the idle ink droplet receiving section 84.

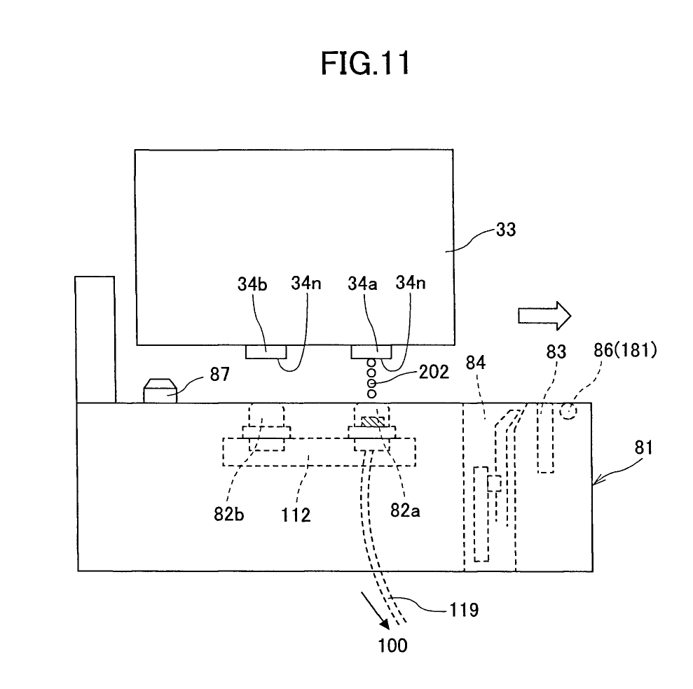

Next, idle ink ejection to the cap member 82 is described. FIG. 11 is a schematic diagram showing first idle ink ejection to the cap member 82 by using the head maintaining and recovering mechanism 81. As shown in FIG. 11, when ink droplets are ejected into the cap member 82a in the first idle ink ejection, the recording head 34a of the carriage 33 is moved to a position facing the cap member 82a and ink droplets 202 which do not contribute to forming an image are ejected by driving the recording head 34a.

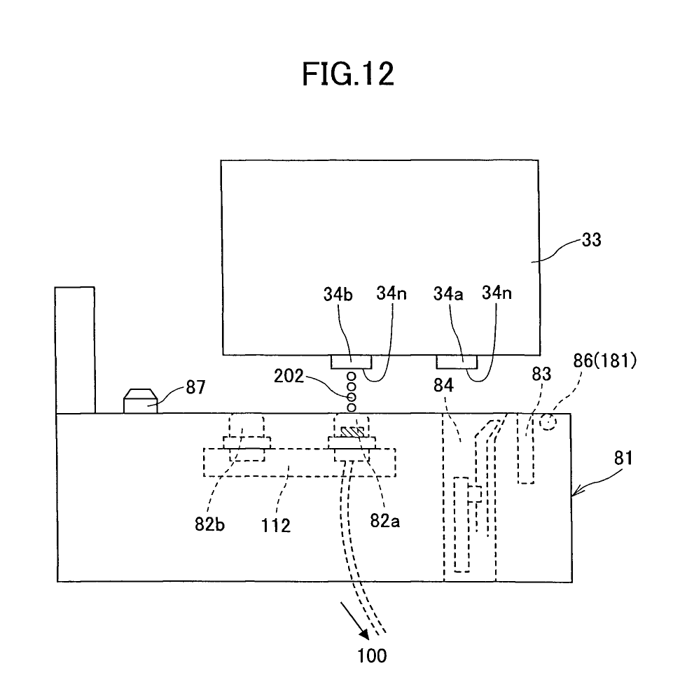

FIG. 12 is a schematic diagram showing second idle ink ejection to the cap member 82 by using the head maintaining and recovering mechanism 81. When ink droplets are ejected to the cap member 82b in the second idle ink ejection by moving the carriage 33 in the white arrow direction shown in FIG. 11, as shown in FIG. 12, the recording head 34b of the carriage 33 is moved to a position facing the cap member 82a and ink droplets 202 which do not contribute to forming an image are ejected by driving the recording head 34b.

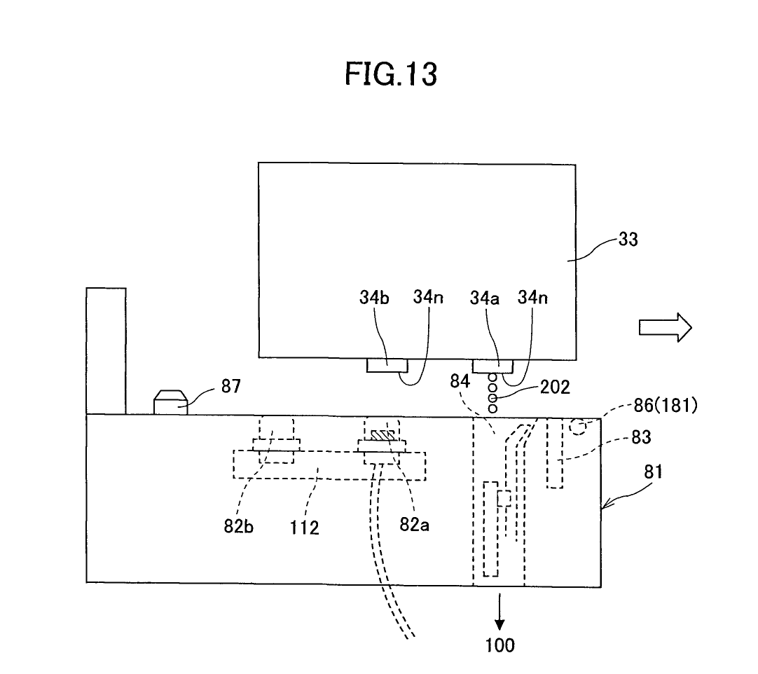

Next, idle ink ejection into the idle ink droplet receiving section 84 is described. FIG. 13 is a schematic diagram showing first idle ink ejection to the idle ink droplet receiving section 84 by using the head maintaining and recovering mechanism 81. As shown in FIG. 13, when ink droplets are ejected into the idle ink droplet receiving section 84 in the first idle ink ejection, the recording head 34a of the carriage 33 is moved to a position facing the idle ink droplet receiving section 84 and the ink droplets 202 which do not contribute to forming an image are ejected by driving the recording head 34a.

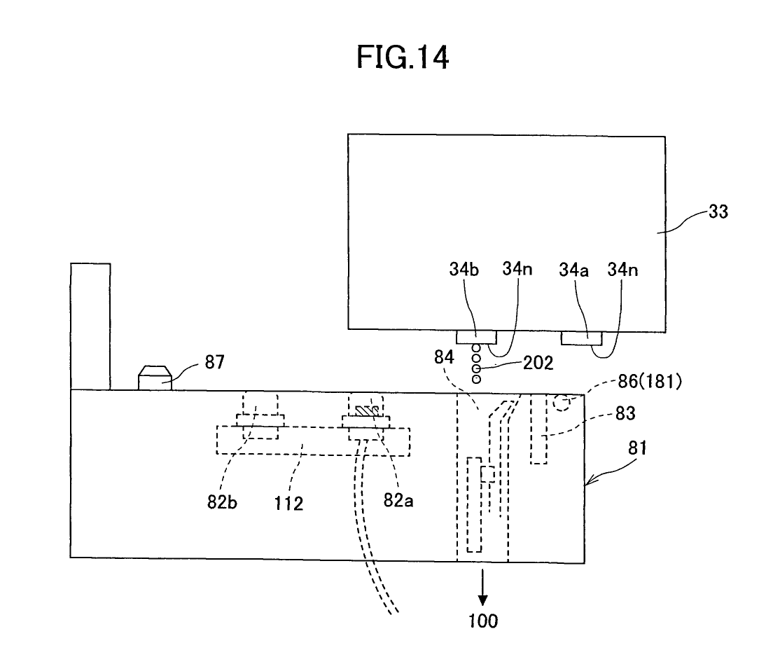

FIG. 14 is a schematic diagram showing second idle ink ejection into the idle ink droplet receiving section 84 by using the head maintaining and recovering mechanism 81. When ink droplets are ejected to the idle ink droplet receiving section 84 in the second idle ink ejection by moving the carriage 33 in the white arrow direction shown in FIG. 13, as shown in FIG. 14, the recording head 34b of the carriage 33 is moved to a position facing the idle ink droplet receiving section 84 and the ink droplets 202 which do not contribute to forming an image are ejected by driving the recording head 34b.

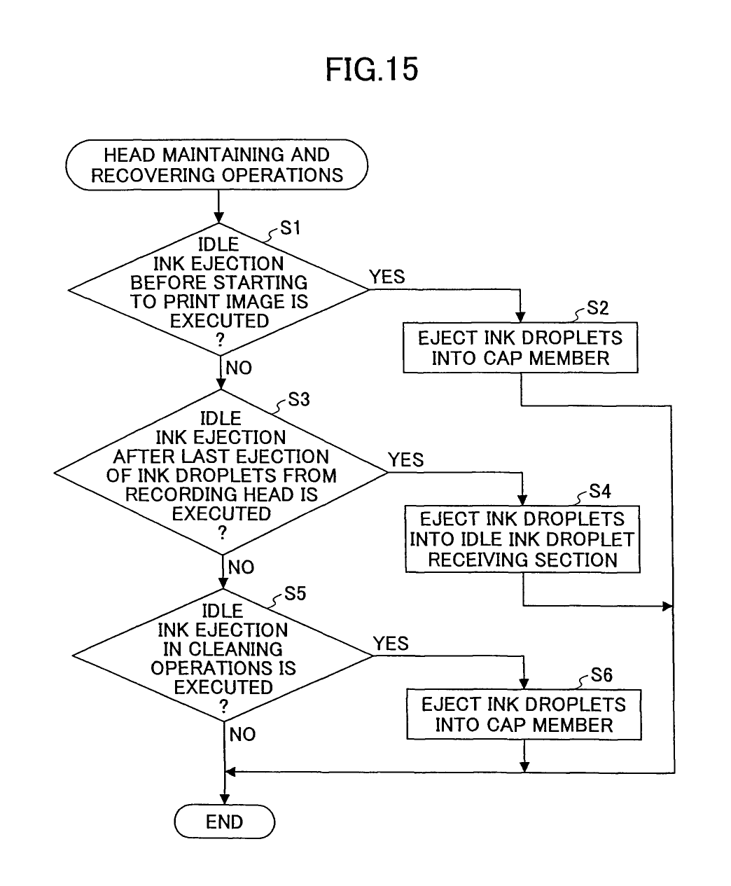

FIG. 15 is a flowchart showing the operations of the idle ink ejection according to the embodiment of the present invention. In FIG. 15, a relationship between the operations of the idle ink ejection and destinations where the ink droplets are ejected by the operations is shown.

In the image forming apparatus, the operations of the idle ink ejection are executed in the following three cases. In the operation of the idle ink ejection, ink droplets which do not contribute to forming an image are ejected.

In a first case, when an image is printed on a recording medium by moving the carriage 33 from the home position facing the head maintaining and recovering mechanism 81 to the printing region in response to a print instruction, ink droplets remaining on the recording head 34 are ejected before starting to print the image at the home position. This idle ink ejection is called idle ink ejection before starting to print an image.

In a second case, the ink droplets are ejected when a predetermined period (first predetermined period) has passed after the last ejection of the ink droplets 202 from the recording head 34. The predetermined period is, for example, 10 hours to one week. This idle ink ejection is called idle ink ejection after the last ejection of the ink droplets from the recording head. In the image forming apparatus, even if the power source of the image forming apparatus is turned off, the predetermined period can be measured.

In addition, in a third case, when another predetermined period (second predetermined period) longer than the first predetermined period has passed after the last ejection of the ink droplets 202 from the recording head 34, the ink droplets are ejected as one of cleaning operations of the recording head 34. In the third case, cleaning operations are executed. In the cleaning operations, the operations of the idle ink ejection are executed with nozzle suctioning operations and/or nozzle surface wiping operations.

Referring to FIG. 15, the operations of the idle ink ejection are described. First, it is determined whether the idle ink ejection before starting to print an image is executed (S1). When the idle ink ejection before starting to print an image is executed (YES in S1), as shown in FIGS. 11 and 12, the carriage 33 is moved to the position where the recording head 34 faces the cap member 82 and the recording head 34 is driven. With this, ink droplets are ejected into the cap member 82 from the recording head 34 (S2).

When the idle ink ejection before starting to print an image is not executed (NO in S1), it is determined whether the idle ink ejection after the last ejection of the ink droplets from the recording head is executed (S3). When the idle ink ejection after the last ejection of the ink droplets from the recording head is executed (YES in S3), as shown in FIGS. 13 and 14, the carriage 33 is moved a position where the recording head 34 faces the idle ink droplet receiving section 84 and the recording head 34 is driven. With this, ink droplets are ejected into the idle ink droplet receiving section 84 from the recording head 34 (S4).

When the idle ink ejection after the last ejection of the ink droplets from the recording head is not executed (NO in S3), it is determined whether the idle ink ejection in the cleaning operations is executed (S5). When the idle ink ejection in the cleaning operations is executed (YES in S5), as shown in FIG. 8, the cap member 82 caps the nozzle surfaces 34n of the recording head 34, the suction pump 120 (see FIG. 3) is driven, and the remaining ink droplets are suctioned into the cap member 82.

In the cleaning operations, the wiping operations for the nozzle surfaces 34n of the recording head 34 are also executed.

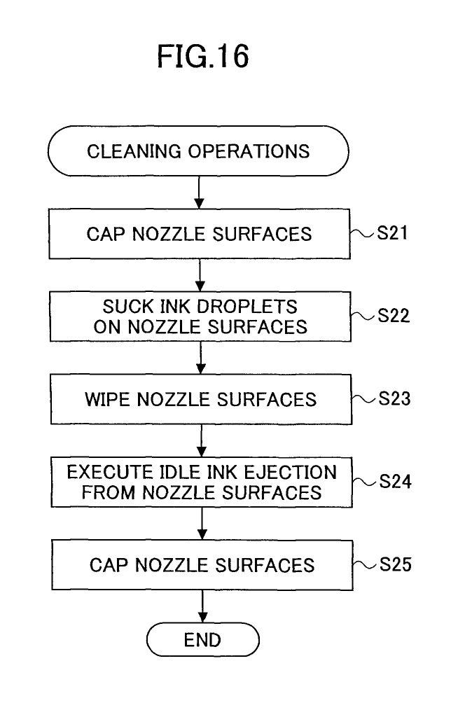

Referring to FIG. 16, an example of the cleaning operations is described. FIG. 16 is a flowchart showing the example of the cleaning operations. First, the cap member 82 caps the nozzle surfaces 34n of the recording head 34 by lifting the cap member 82 (S21), and ink droplets on the nozzle surfaces 34n of the recording head 34 are suctioned by driving the suction pump 120 (S22). Then the cap member 82 is moved downward, the wiper member 83 is lifted, and the carriage 33 is moved to the wiper member 83. With this, the nozzle surfaces 34n of the recording head 34 are wiped by the wiper member 83 and the waste ink 201 on the wiper member 83 is scraped into the idle ink droplet receiving section 84 by moving the wiper member 83 downward (S23). Then idle ink ejection is executed from the nozzle surfaces 34n of the recording head 34 to the cap member 82 (S24), and the nozzle surfaces 34n are capped by the cap member 82 by lifting the cap member 82 (S25).

As described above, when the operations of the idle ink ejection are executed before starting to print an image, the ink droplets 202 are scraped into the cap member 82 and the scraped ink droplets are discharged into the waste ink tank 100. When the operations of the idle ink ejection are executed when a predetermined period has passed after the last ejection of the ink droplets 202 from the recording head 34, the ink droplets 202 are scraped into the idle ink droplet receiving section 84 and the scraped ink droplets are discharged into the waste ink tank 100. When the operations of the idle ink ejection in the cleaning operations are executed, the ink droplets are scraped into the cap member 82 and the scraped ink droplets are discharged into the waste ink tank 100.

Therefore, a stack of viscosity-increased ink droplets is hardly formed in the waste ink tank 100 and the idle ink droplet receiving section 84. Consequently, the service lives of the waste ink tank 100 and the idle ink droplet receiving section 84 can be prevented from being shortened. In addition, the service life of the image forming apparatus can be prevented from being shortened.

The waste ink tank 100 can be detachable from the image forming apparatus. However, since the idle ink droplet receiving section 84 is in the head maintaining and recovering mechanism 81, it is difficult for the idle ink droplet receiving section 84 to be detachable from the image forming apparatus.

In a case where the operations of the idle ink ejection are executed when a predetermined period has passed after the last ejection of the ink droplets 202 from the recording head 34, the execution of the operations depends on using conditions of the image forming apparatus. Therefore, in this case, the waste ink is first discharged into the idle ink droplet receiving section 84. Consequently, the service life of the idle ink droplet receiving section 84 can be reliably predicted and the service life of the image forming apparatus can be reliably predicted.

In the three cases of the idle ink ejection, the total amount of the ink droplets to be ejected has the following relationship; the amount of the ink droplets to be ejected by the idle ink ejection before starting to print an image<the amount of the ink droplets to be ejected by the idle ink ejection after the last ejection of the ink droplets from the recording head<the amount of the ink droplets to be ejected by the cleaning operations. By using the relationship in which the total amounts of the ink droplets to be ejected are different from each other in the three cases, the recording head 34 ejects the ink droplets into at least one of the idle ink droplet receiving section 84 and the cap member 82. Therefore, the service lives of the waste ink tank 100 and the idle ink droplet receiving section 84 can be prevented from being shortened. In addition, the service life of the image forming apparatus can be prevented from being shortened.

The image forming apparatus according to the present embodiment is not limited to an inkjet printer, and can be a facsimile machine, a copier, or a multifunctional peripheral combining the above functions. In addition, the recording liquid is not limited to ink, and can be resist liquid, for example, in manufacturing a semiconductor device, and a DNA sample; that is, the image forming apparatus according to the present embodiment can be applied to a semiconductor manufacturing apparatus and a medical instrument.

Further, the present invention is not limited to the specifically disclosed embodiment, and variations and modifications may be made without departing from the scope of the present invention.

The present invention is based on Japanese Priority Patent Application No. 2007-139789, filed on May 26, 2007, with the Japanese Patent Office, the entire contents of which are hereby incorporated herein by reference.

What is claimed is:

1. An image forming apparatus, comprising:
a recording head having nozzles which eject liquid droplets for forming an image on a recording medium; and
a head maintaining and recovering mechanism; wherein
the head maintaining and recovering mechanism includes
a cap member for capping a nozzle surface of the recording head;
a wiper member for wiping the nozzle surface of the recording head so that the liquid droplets remaining on the nozzle surface are wiped;
a wiper cleaning member for scraping the wiper member so that the liquid droplets remaining on the wiper member are removed from the wiper member; and
an idle liquid droplet receiving section which receives the liquid droplets ejected from the recording head not contributing to forming the image and also receives the liquid droplets scraped from the wiper member; wherein
the recording head executes a plurality types of idle liquid droplet ejections by ejecting the liquid droplets not contributing to forming the image according to a time period during the recording head not ejecting liquid droplets; and
the recording head ejects the liquid droplets into the idle liquid droplet receiving section in a first case of the idle liquid droplet ejection when a first predetermined period has passed after the last ejection of the liquid droplets from the recording head, and ejects the liquid droplets into the cap member in cases other than the first case of the idle liquid drop let ejection.

2. The image forming apparatus as claimed in claim 1, wherein:
a case other than the first case is a case where the idle liquid droplet ejection is executed before starting to form the image on the recording medium.

3. The image forming apparatus as claimed in claim 1, wherein:
a case other than the first case is a case where the idle liquid droplet ejection is executed after a second predetermined period longer than the first predetermined period has passed as one of cleaning operations of the recording head.

4. An image forming apparatus, comprising:
a recording head having nozzles which eject liquid droplets for forming an image on a recording medium; and
a head maintaining and recovering mechanism; wherein
the head maintaining and recovering mechanism includes
a cap member for capping a nozzle surface of the recording head;
a wiper member for wiping the nozzle surface of the recording head so that the liquid droplets remaining on the nozzle surface are wiped;
a wiper cleaning member for scraping the wiper member so that the liquid droplets remaining on the wiper member are removed from the wiper member; and
an idle liquid droplet receiving section which receives the liquid droplets ejected from the recording head not contributing to forming the image and also receives the liquid droplets scraped from the wiper member; wherein
the recording head executes a plurality types of idle liquid droplet ejections, amount of total ejected liquid droplets of which are different from each other, by ejecting the liquid droplets not contributing to forming the image; and
the recording head ejects the liquid droplets into at least one of the idle liquid droplet receiving section and the cap member according to the total ejected liquid droplets ejected by the plurality types of idle liquid droplet ejections.
